(19) United States
(12) Patent Application Publication
(10) Pub. No.: US 2019/0066449 A1
(43) Pub. Date: Feb. 28, 2019

(54) Interactive Wagering Machine

(71) Applicant: BUDDYBET PTY LTD, Doncaster (AU)

(72) Inventors: Jesse Gill, Templestowe (AU); Scott Didier, Templestowe (AU)

(21) Appl. No.: 15/691,176

(22) Filed: Aug. 30, 2017

(51) Int. Cl. G07F 17/32; A63F 13/795

(52) U.S. Cl. CPC G07F 17/3288; G07F 17/3244; G07F 17/3209; G07F 17/3225; A63F 13/795; G07F 17/3211

(57) ABSTRACT

A betting machine is used by a computer, having a visible screen. The computer is programmed to provide a user interface on the visible screen. The user interface provides options for placing an interactive wager with another user. The options displaying a first option to create a wager along with characteristics of the wager including an amount of the wager, and displaying odds for the wager, and a second option to accept a wager from another user, by accepting the amount of the wager and the conditions of the wager and the odds of the wager. The computer operates over a network connection to send and receive information about the wagers. The computer is also programmed to provide a summary of conditions of the wager to both the first and second users. The computer is also programmed to manage user interface screens that are shown to both the creator of the bet and to the acceptor of the bet by providing a user interface screen to the creator of the bet allowing the creator of the bet to select a winner for the bet. A user interface screen is provided to the acceptor of the bet allowing the creator of the bet to select a winner for the bet, where the machine accepts one of the users as winning the bet only when both the creator and the acceptor both select the same winner. Then the users both can rate the other party.

### BACKGROUND

Wagering and/or gambling machines use an automated computer based rules system to allow a wager to be made against the rules that are stored in the machine. Such wagering machines may take the form of slot machines, card machines, and others. One advantage is that no human interaction is necessary or even possible. Hence there is no possibility of human error or cheating by humans.

However, existing wagering machines accept only certain defined kinds of wagers.

### SUMMARY

The present application describes a betting machine and system that enables many different kinds of bets to be handled by the machine.

Embodiments allow users to define (to be completed).

### BRIEF DESCRIPTION OF THE DRAWINGS

in the drawings:

FIG. 1 shows an architecture;

FIG. 2 shows a flowchart of operation;

FIGS. 3A, 3B, 4A, 4B and 4C show user interface screens on a client;

FIG. 5 shows a welcome screen;

FIGS. 6A and 6B show betting screens;

FIG. 7 shows a map of locality;

FIGS. 8A-8D show creating a bet; and

FIGS. 9A-9G show accepting a bet and processing the bet.

### DETAILED DESCRIPTION

The present application describes a betting machine which facilitates betting between users. According to an embodiment, one of the users communicates with one machine. The machine includes a computer and a network connection. The machine communicates via a network to provide information from the user to other users, as explained herein.

In the embodiment, the users define characteristics for the bets, and accept the bets made by others, as described herein.

FIG. 1 illustrates the basic architecture of the system, in which a first machine 100 includes the ability to use a user interface on the machine to set up a bet that can be accepted by another person. The machine 100 may be connected via a network 110 to a number of other machines shown generically as machine 2 120, other machines, up to machine n 130. However it should be understood that when the network is the Internet or a cellular network, that there could be any number of machines, and that the machines can connect to one another in any desired way.

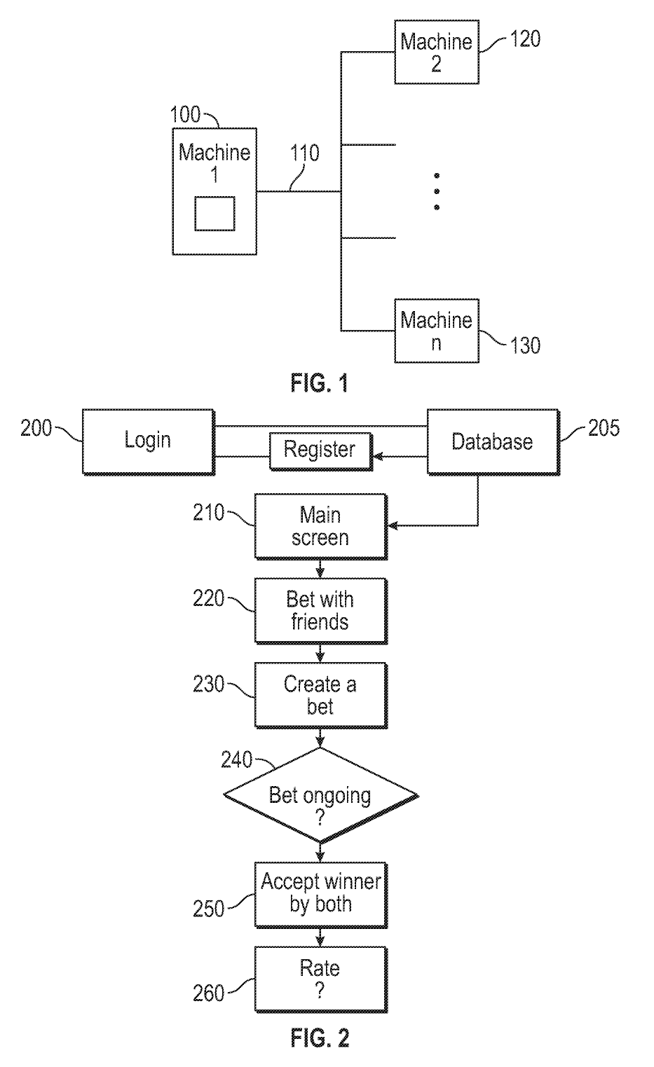

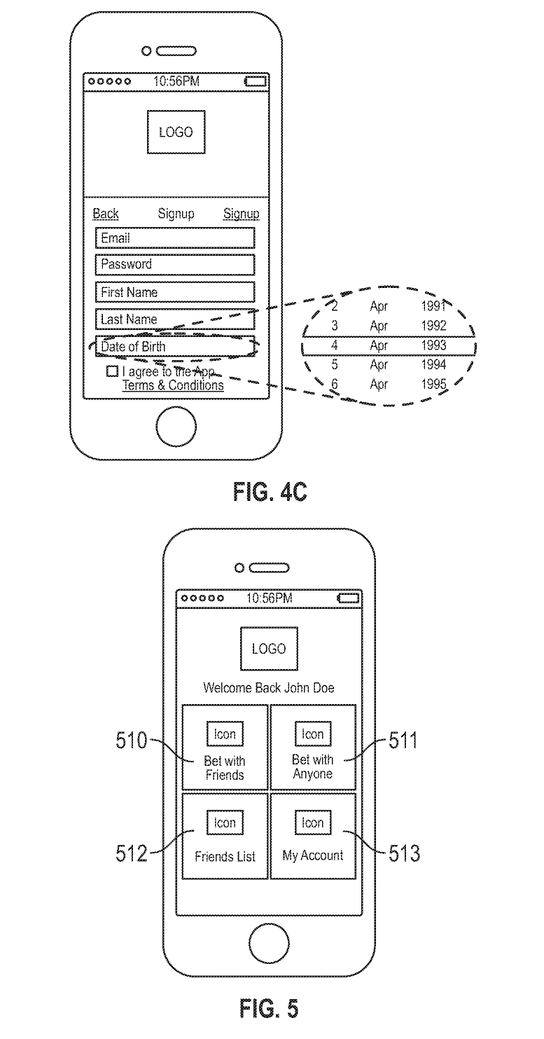

The user machine, such as 100, can run the flowchart shown generally in FIG. 2. The operation starts at 200, where a user logs in, e.g. using the screen of FIG. 4A. This can be done, for example with an email address and password as in FIG. 4B, or with Facebook or a using some other login service. The users profile information is automatically populated into the machine after the login from information from a database 205. The login can use either a local database of information or a remote database which is accessible over the network.

If the user has not previously logged in, the user can register using the screen of FIG. 4C.

After the data is populated, the user is returned to receive the main user interface shown as 210. The main user interface is shown in FIG. 5, with a basic 4 button simplified interface which enables the logged-in user to bet with friends at 510 which are friends that have been previously established, either on the machine itself or on a social network such as Facebook, to bet with anyone at 511, to view or manage friends at 512, or to view their account information at 513.

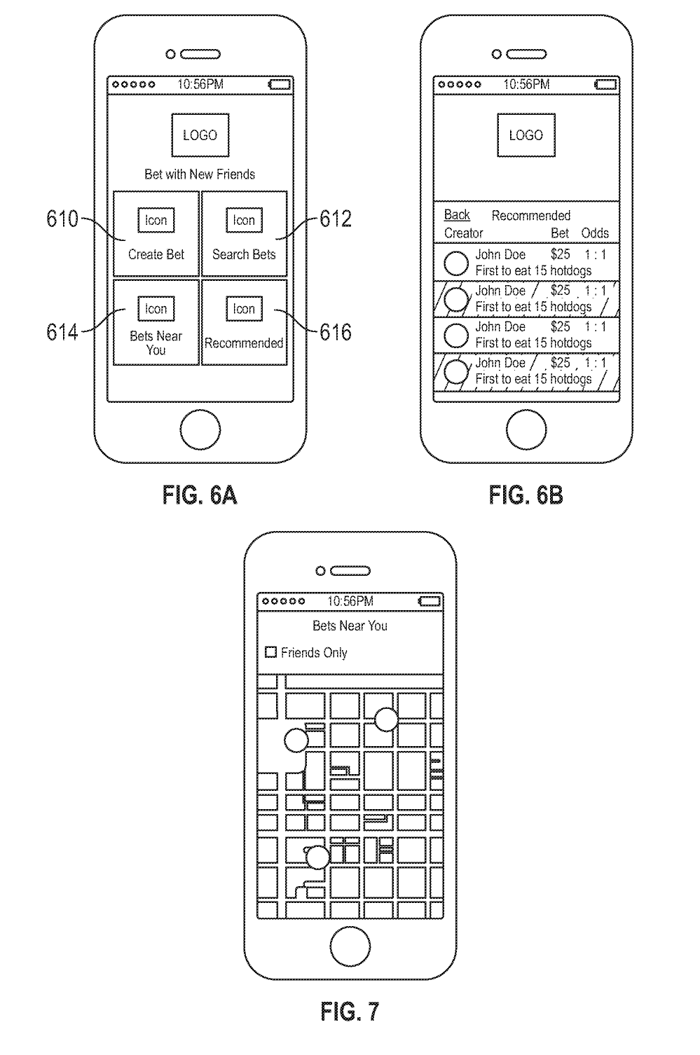

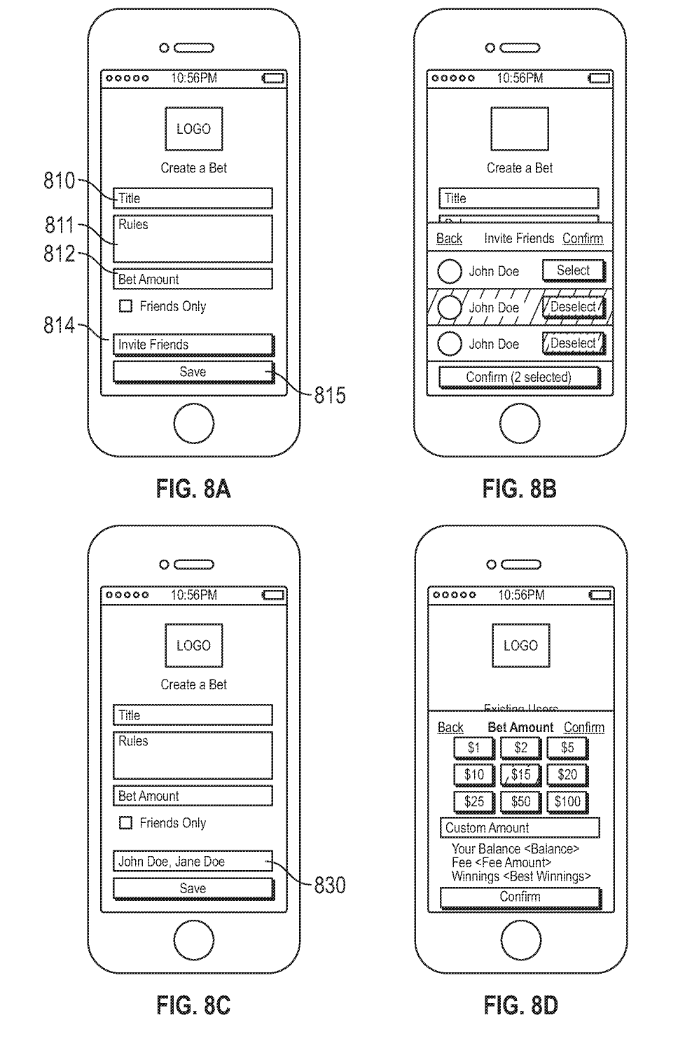

If the user selects to bet with friends by selecting 510, they receive the further 4 button interface screen at 220 and shown in FIG. 6. In this 4 button interface, the user is given some choices for betting. At 610, the user is enabled to create a bet, by entering in information about what kind of bet the user wants to create, shown in the user interface screen in FIG. 8. At 612, the user can search bets, that is look for bets that other friends have created, that they might be interested in.

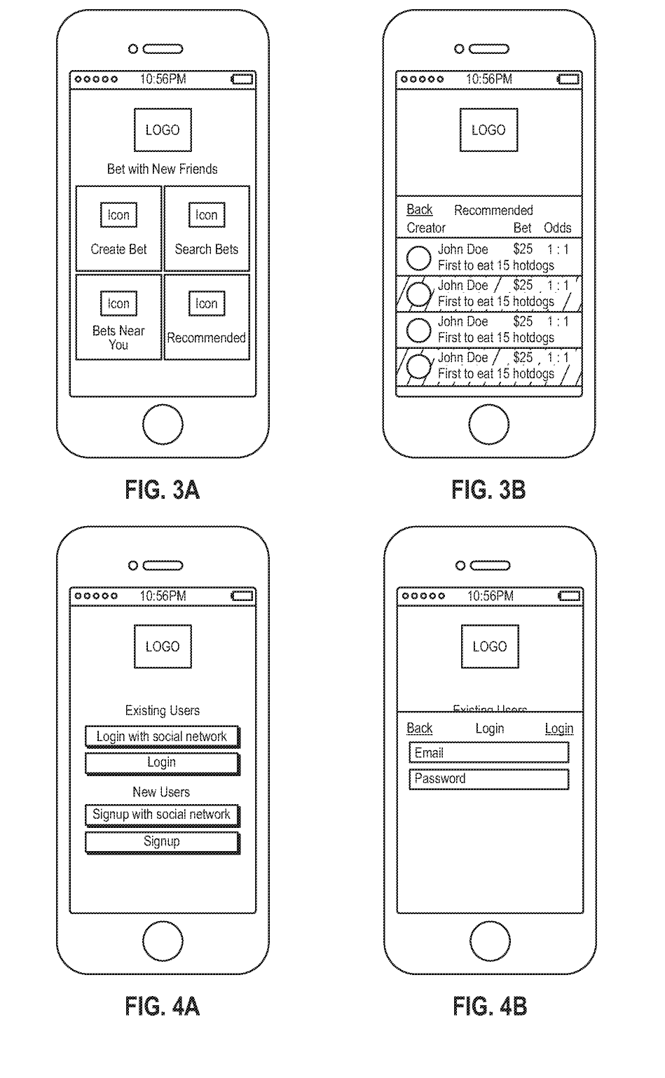

The user can also choose to bet with anyone, in essence looking for new betting friends, which provides the screens of FIGS. 3A and 3B.

614 represents a map of nearby bets, thus enabling a user to find a bet that is close the user's current location. If the user selects to look at nearby bets at 614, they get the bet screen of FIG. 7, showing the nearby bets on a map. If the nearby bets embodiment is carried out, the machine determines the current location and uses that as part of the betting process.

616 represents the recommended bets which are determined by the user's list of friends and keywords in the title and rules of the bet that are detected to be important. For example, if the user has previously bet on sports or common activities, those keywords are cross-referenced against the user's betting history to detect their interests. An exemplary screen of recommended bets is shown in FIG. 6B, which shows the bets including their creator, amounts, odds and terms.

If the user chooses to create a bet at 610, the user receives the create a bet screen at 230. FIG. 8A shows more details on this screen. The user enters the title at 810, and the rules of the bet which can be any rules whatsoever at 811. The bet amount is selected at 812 to bring up the bet amount screen in FIG. 8D, which allows setting the bet amount and shows the user's balance and the fees for the bet.

The create screen also shows parameters 814 such as friends only, and/or location enabled. The user is also given an opportunity to invite friends 815, which brings up the screen in FIG. 8B. After selecting friends in FIG. 8B, the selected friends show up as 830 in the friends list, shown in FIG. 8C. Once the user finishes, the user is given the opportunity to save the bet. If a location is enabled, then the bet only shows up on other user's machines when they look for the “bets near you” option.

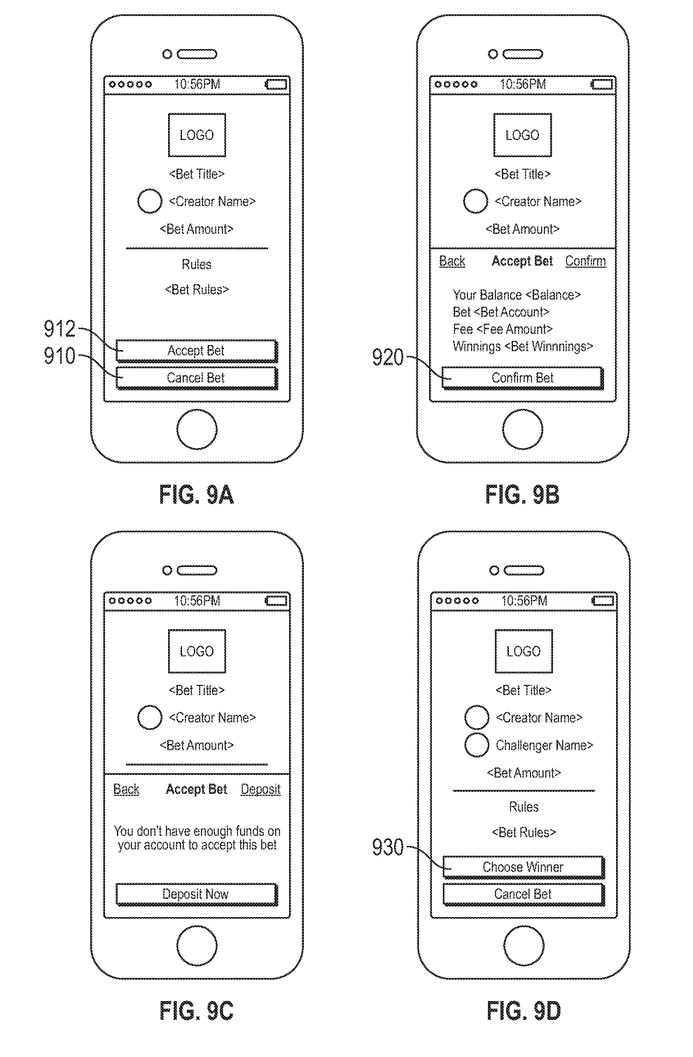

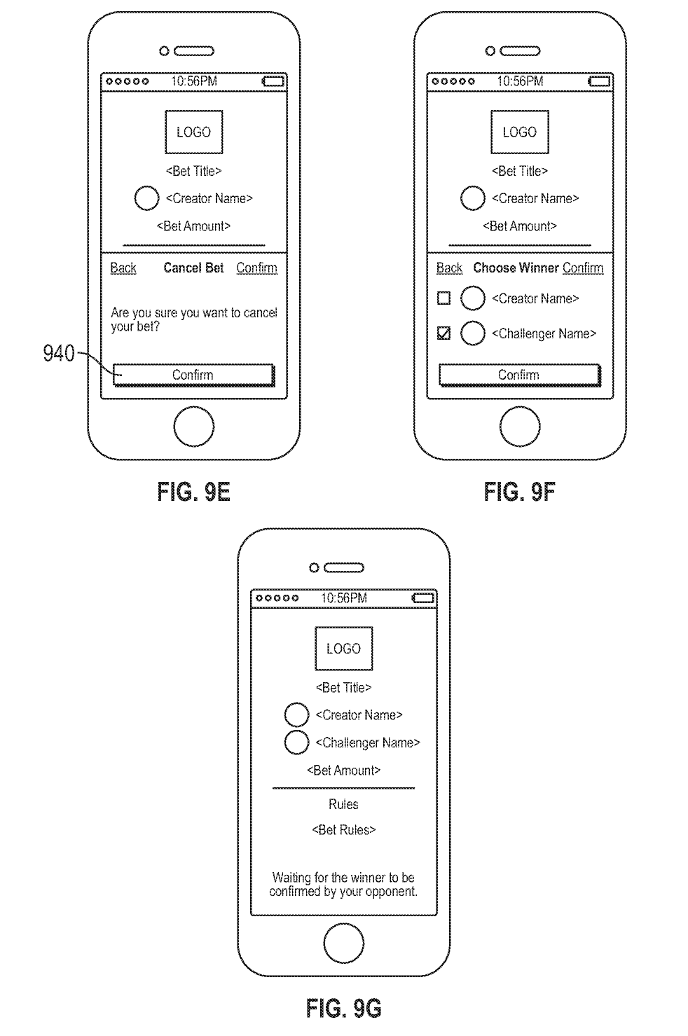

The bet details are provided to any user who wants to look for a bet. For example, if the user selects option 612, and chooses one of the bets, the user may see the specifics of the bet shown in FIG. 9A. This shows bet title, creator name and bet amount and rules of the bet. If the viewer is a creator, they have the option to cancel the bet at 910. If the viewer is not a creator, the user has the option to join/accept the bet at 912.

To accept the bet, the user can punch the accept key 912, thus providing them the accept screen of FIG. 9B. In this screen, the user is shown their balance, the betting amount, the fee for the actual platform, and the potential winnings. If the user presses confirm bid at 920, then their balance is deducted for the amount of the bet if the user's balance is sufficient. If not, at FIG. 9C, the user is asked to deposit more funds to cover the bet. At this point, the bet is in progress, and no one else can accept the bet.

At this point, the bet has been accepted and is ongoing at 240. This provides a bet details screen at FIG. 9D, which shows the bet, the characteristics, the people in the bet, and enables the user to choose a winner by selecting button 930.

The creator of the bet can cancel the bet as shown in FIG. 9E.

Either party can declare a winner of the bet as shown in FIGS. 9F and 9G.

A power of this system is that the participants are asked to choose a winner, and no winner is declared unless the bet is resolved by both parties to the bet at 250. If the user chooses a winner at 930, then the other user is asked to confirm by providing them with the screen of FIG. 9E, shown as 940. Only when both users agree on the choices, the bet is resolved and the winner's balance credited with the winning. The fee for the system is taken from the actual winning. If the users disagree, then the bet amount is refunded to both parties.

However, users are given the opportunity to rate other users at 260 to allow users to avoid bets with those who are rated as not having treated the bet fairly. If the outcome is resolved, each user is able to give a star rating to the other user. That means that if one or both users are not satisfied with the result of the bet, they can give a low star rating. However, users that are intellectually honest about the results of the bet get a better star rating. This enables the different users to have different degrees of confidence in the others bets.

The power of the system is that the users can select anything whatsoever to bet on. The users manage whether the bets are met or not met. The user is not satisfied with the honesty of the other user can give them a low star rating, and people with overall low star ratings will be much less likely to be allowed in to a bet. The system takes its cut of every earning, and thus even though the machine need not understand the bet, the machine will enable the users to place any bet and mediate between themselves to decide/determine the winner of the bet.

In one embodiment, the machine may be a computer running on a portable telephone. In this embodiment, the different operations which are described herein can be carried out on the screen of the telephone.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other clients can be used as the computer. Other screens can be used.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

Functions can also be carried out by programmed computer readable media which can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A betting machine, comprising:
a computer, having a visible screen, the computer programmed to provide a user interface on the visible screen, where the visible screen shows the user interface to provide options for placing an interactive wager with another user, the options displaying a first option to create a wager along with conditions of the wager including an amount of the wager, by accepting the amount of the wager and the conditions of the wager and,
the computer having a network connection to send and receive information about the wagers,
the computer also programmed to provide a summary of conditions of the wager to both a creator of the interactive wager and to an acceptor of the interactive wager,
and also to manage user interface screens that are shown to both the creator of the interactive wager and to the acceptor of the interactive wager,
by providing a user interface screen to the creator of the interactive wager allowing the creator of the interactive wager to select a winner for the interactive wager,
and by providing a user interface screen to the acceptor of the interactive wager allowing the acceptor of the interactive wager to select a winner for the interactive wager,
where the machine accepts either the creator of the interactive wager or the acceptor of the interactive wager as winning the interactive wager only when both the creator and the acceptor both select the same winner and does not accept the as winning the interactive wager when either of the creator or the acceptor do not select the same winner and the machine provides a winning amount to the winning user only when determining the interactive wager as having been won.

2. The machine as in claim 1, where both the creator and the acceptor receive an option to rate the other user after the interactive wager has been completed and to record and store ratings of the users.

3. The machine as in claim 1, where both users are refunded the interactive wager amount if the creator and the acceptor do not both select the same winner.

4. The machine as in claim 1, where the machine collects the amounts of the interactive wager from both users, and provides a winning amount to the winning user, after deducting an amount as a system fee.

5. The machine as in claim 1, wherein each user includes a list of friends.

6. The machine as in claim 5, wherein each user has an option to allow the interactive wager only to be offered to the user's friends.

7. The machine as in claim 1, wherein the machine's location is determined and the location is used as part of the interactive wager.

8. The machine as in claim 7, wherein each user is given the option only to interactive wager on wagers within a certain area.

9. The machine as in claim 1, wherein the machine is a cellular phone programmed for running a computer program that the user interface, and the network connection is over a cellular network.

10. A method of operating a betting machine, comprising:
operating a computer, having a visible screen, to display information on the screen and to receive inputs from a user of the computer,
the information on the screen including a user interface on the visible screen, where the visible screen shows the user interface to provide options for placing an interactive wager with another user,
displaying a first option to create a wager along with conditions of the wager including an amount of the wager, and
by accepting the amount of the wager and the conditions of the wager,
sending and receiving information about the wagers over a network connection,
providing a summary of conditions of the wager to both a creator of the interactive wager and an acceptor of the interactive wager,
managing user interface screens that are shown to both the creator of the interactive wager and to the acceptor of the interactive wager,
providing a user interface screen to the creator of the interactive wager allowing the creator of the interactive wager to select a winner for the interactive wager,
providing a user interface screen to the acceptor of the interactive wager allowing the acceptor of the interactive wager to select a winner for the interactive wager,
accepting one of the either the creator of the interactive wager or the acceptor of the interactive wager as winning the interactive wager only when both the creator and the acceptor both select the same winner.

11. The method as in claim 10, further comprising providing both the creator and the acceptor with an option to rate the other user after the interactive wager has been completed.

12. The method as in claim 10, further comprising refunding a interactive wager amount if the creator and the acceptor do not both select the same winner.

13. The method as in claim 10, further comprising collecting an amount of the interactive wager from both users, and providing a winning amount to the winning user, after deducting an amount as a system fee.

14. The method as in claim 10, further comprising providing a list of friends to each user.

15. The method as in claim 14, wherein each user has an option to allow the interactive wager only to be offered to the user's friends.

16. The method as in claim 10, further comprising determining a position of the computer and using the location as part of the interactive wager.

17. The method as in claim 16, further comprising providing each user with the option only to interactive wager on wagers within a certain area.
